(19) United States
(12) Patent Application Publication
(10) Pub. No.: US 2025/0390154 A1
(43) Pub. Date: Dec. 25, 2025

(54) METHODS AND APPARATUS TO DETERMINE POWER STAGE INFORMATION USING TELEMETRY DATA

(71) Applicant: Texas Instruments Incorporated, Dallas, TX (US)

(72) Inventors: Matthew John Ascher Schurmann, Wylie, TX (US); Preetam Charan Anand Tadeparthy, Bangalore (IN); Vikram Gakhar, Bangalore (IN); Vikas Lakhanpal, Bangalore (IN); Kevin La Rosa, Sachse, TX (US)

(21) Appl. No.: 18/748,943

(22) Filed: Jun. 20, 2024

(51) Int. Cl. G06F 1/28; G06F 1/30

(52) U.S. Cl. CPC G06F 1/28; G06F 1/305

(57) ABSTRACT

Methods, apparatus, systems, and articles of manufacture are described to determine power stage information using telemetry data. An example apparatus includes a power stage configured to output a voltage; and a controller configured to: drive the power stage; receive telemetry data related to the power stage; determine information related to the power stage based on the telemetry data; and transmit the determined information via a network communication.

### TECHNICAL FIELD

This description relates generally to circuitry, and, more particularly, to methods and apparatus to determine power stage information using telemetry data.

### BACKGROUND

Electronic devices, such as servers in a datacenter, can be powered using one or more power stages that provide a voltage and/or current to the electronic devices. Power stages may include one or more transistors that are controlled by one or more control signals to drive the power stage to generate an output voltage and/or current based on the one or more control signals.

### SUMMARY

For determining power stage information using telemetry data, an example apparatus includes a power stage configured to output a voltage; and a controller configured to: drive the power stage; receive telemetry data related to the power stage; determine information related to the power stage based on the telemetry data; and transmit the determined information via a network communication. Other examples are described.

For determining power stage information using telemetry data, an example method includes receiving, by a controller, analog telemetry power stage data; converting, by an analog-to-digital (ADC) converter of the controller, the analog power stage telemetry data to digital telemetry data; determining, by digital circuitry of the controller, a power stage characteristic based on the digital telemetry data; and transmitting, by the controller, the power stage characteristic.

For determining power stage information using telemetry data, an example apparatus includes a driver including an input terminal and an output terminal, the output terminal of the driver structured adapted to be coupled to a power stage; a first analog-to-digital converter including an input terminal and an output terminal, the input terminal of the first analog-to-digital converter structured adapted to be coupled to at least one of a terminal of a power converter, a terminal of the power stage, or a terminal of a load device; a second analog-to-digital converter including an input terminal and an output terminal, the input terminal of the second analog-to-digital converter structured adapted to be coupled to at least one of the terminal of the power converter, the terminal of the power stage, or the terminal of the load device; and digital circuitry including an output terminal, a first input terminal, and a second input terminal, the output terminal of the digital circuitry coupled to the input terminal of the driver, the first input terminal of the digital circuitry coupled to the output terminal of the first analog-to-digital converter, the second input terminal of the digital circuitry coupled to the output terminal of the second analog-to-digital converter. Other examples are described.

### BRIEF DESCRIPTION OF THE DRAWINGS

FIG. 1 is an example block diagram of a system for implementing a controller to determine power stage information using telemetry data.

FIG. 2 is a block diagram of example digital circuitry of FIG. 1.

FIGS. 3-7 illustrate flowcharts representative of example machine readable instructions or example operations that may be executed, instantiated, or performed by example programmable circuitry to implement a controller and/or the digital circuitry of FIGS. 1 and/or 2.

FIGS. 8A-8C illustrate example signal plots used by the digital circuitry of FIG. 1 to determine power stage information.

FIG. 9 is a block diagram of an example processing platform including programmable circuitry structured to execute, instantiate, or perform the example machine readable instructions or perform the example operations of FIGS. 3-7 to implement the digital circuitry of FIGS. 1 and/or 2.

The same reference numbers or other reference designators are used in the drawings to designate the same or similar (functionally or structurally) features.

### DETAILED DESCRIPTION

The drawings are not necessarily to scale. Although the drawings show regions with clean lines and boundaries, some or all of these lines or boundaries may be idealized. In reality, the boundaries or lines may be unobservable, blended or irregular.

Datacenters include racks of servers that include processing units (e.g., a central processing unit (CPU), a graphics processing unit (GPU), etc.). For example, a datacenter may include thousands of racks, each including a number of servers. Each server is powered by multiple power stages (e.g., 25 to 100 power stages per server). Thus, datacenters include a large number of power stages. Customers may expect datacenters to be fully operational continuously for a number of years (e.g., 10 years). Downtime of a server in a datacenter can cost some customers hundreds of thousands of dollars every hour.

One reason for downtime in a server is a failure of a power stage. Power stage manufacturers apply vigorous testing of power stages to avoid power stage failure. However, some power stages may not show signs of a power stage failure for months or years after implementation. As environmental conditions of servers in datacenters become stricter, the probability of power stage failure increases. Additionally, because such servers may contain sensitive data, it may be difficult to access servers to analyze for signs of power stage or other failures. Latent power stage failure is difficult to debug due to the lack of data and/or physical access to data related to the servers and/or power stages.

Examples described herein utilize high-speed analog to digital converters and/or high-speed digital circuitry to collect telemetry data (also referred to as telemetry power stage data or analog telemetry power stage data) related to the health and/or status of a power stage. Additionally, examples described herein determine other metrics related to the health and/or status of a power stage based on the collected telemetry data. The telemetry data may include a power stage input voltage, a power stage output voltage, a power stage input current, a power stage output current, power stage control metrics, power stage temperature, etc. The determined metrics may include capacitance shifting of output capacitors, detection of equivalent series resistance (ESR)/equivalent series inductance ESL shifting of the output capacitors, power stage current sense drift, power stage leakage, power stage on voltage shift of a transistor of the power stage, output inductance shifting, detection of ADC controller/clock drift or PCB aging, cooling failures, on-resistance shift, rise/fall times, thermal performance, inductor core loss, etc.

Examples disclosed herein timestamp the sampled telemetry data and/or determined metrics and transmit to a second controller to be transmitted to another device for analysis and/or storage. In this manner, a user, administrator, and/or computing device of the datacenter can process the telemetry data and/or determined metrics to predict power stage failures before they happen. Thus, a technician can be sent out to replace and/or fix a power stage before a power failure occurs. Thus, examples disclosed herein result in less downtime of a datacenter.

Additionally, when an ADC collects, receives, and/or samples analog telemetry data related to the health of a power stage, the ADC converts the analog telemetry data to digital telemetry data and stores the digital telemetry sample in a buffer. The buffer may include a number of previous samples (e.g., 32 samples) which correspond to the 32 previously sampled digital telemetry values. Examples disclosed herein can identify state changes in the system (e.g., based on a communication packet from the server that triggers a change in the output voltage, enabling/disabling a power stage, changing to a low power or high-power mode, etc.) and, in response to a stage change, stop the operation of the ADC. In this manner, because the buffer holds the previous telemetry data samples, examples disclosed herein can provide the samples in the buffer after a state change occurs to an external device. Thus, an administrator and/or computing device can analyze the previous telemetry data to provide additional insight as to why the controller may have requested a state change, which may relate to the health of the power stage and/or identification of an issue.

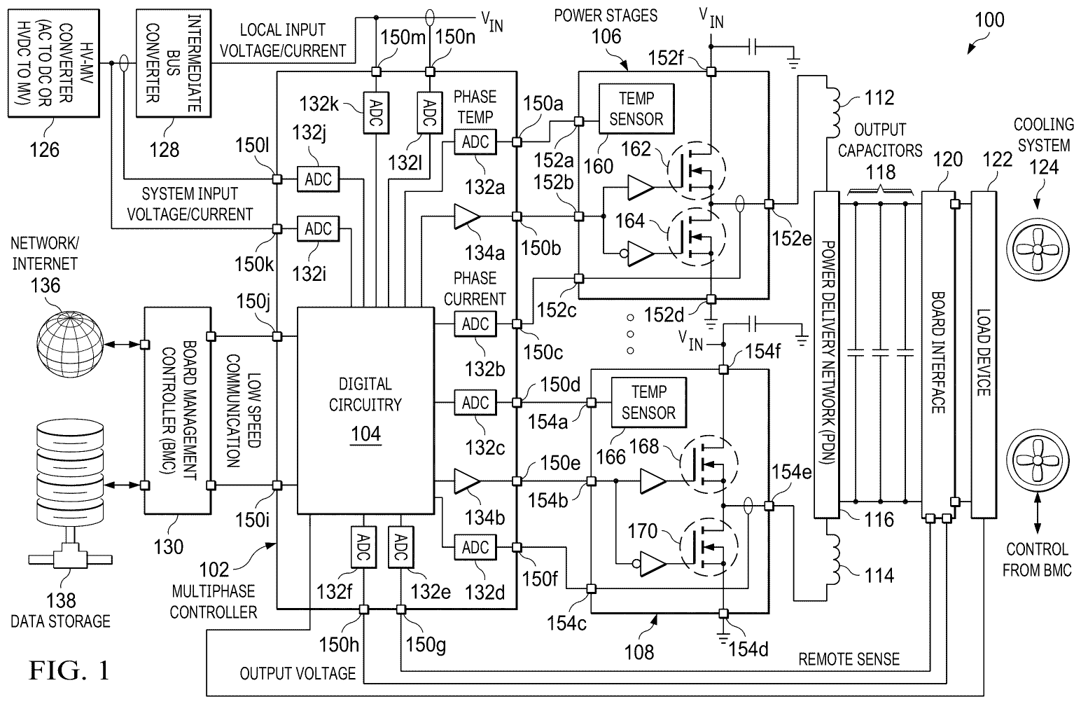

FIG. 1 illustrates an example system 100 for controlling and monitoring a load device, such as a server in a datacenter. The example system 100 includes an example multiphase controller 102 containing example digital circuitry 104, example analog-to-digital converters 132a-131l, and example drivers 134a through 132b. The system 100 further includes a first example power stage 106 through an nth example power stage 108, example inductors 112 through 114, an example power delivery network 116, example capacitors 118, an example board interface 120, an example load device 122, an example cooling system 124, example power converters 126, 128, an example board management controller (BMC) 130, an example network 136, and an example external storage device 138.

The multiphase controller 102 of FIG. 1 is a controller that communicates with the load device 122 and/or the board management controller (BMC) 130 to control the power stages 106 through 108 to provide power to the load device 122. The multiphase controller 102 controls the power stages 106 through 108 using a signal (e.g., a pulse width modulated signal) to the corresponding drivers 134a through 134b to control the output voltages at the output of the power stages 106 through 108. Additionally, as further described below, the multiphase controller 102 determines data related to the health of the power stages 106 through 108 based on telemetry data collected by the ADCs 132a-132l. The multiphase controller 102 includes a number of terminals 150a-150n. For example, the multiphase controller 102 includes a first terminal 150k and a second terminal 150l coupled to the power converters 126, 128. Additionally, the multiphase controller 102 includes a third terminal 150m and a fourth terminal 150n coupled to the power converter 128 and the power stages 106 through 108. Additionally, the multiphase controller 102 includes a fifth terminal 150a and sixth terminal 150d coupled to temperature sensors 160, 166 of the power stages 106 through 108. Additionally, the multiphase controller 102 includes a seventh terminal 150b and an eighth terminal 150e coupled to input drivers of the power stages 106 through 108. Additionally, the multiphase controller 102 includes a ninth terminal 150c and a tenth terminal 150f coupled to the output of the power stages 106, 108. Additionally, the multiphase controller 102 includes an eleventh terminal 150h and a twelfth terminal 150g coupled to the board interface 120. Additionally, the multiphase controller 102 includes a thirteenth terminal 150i and a fourteenth terminal 150j coupled to the BMC 130. Additionally, the multiphase controller 102 may include a fifteenth terminal coupled to the load device 122 (e.g., to obtain communication data packets).

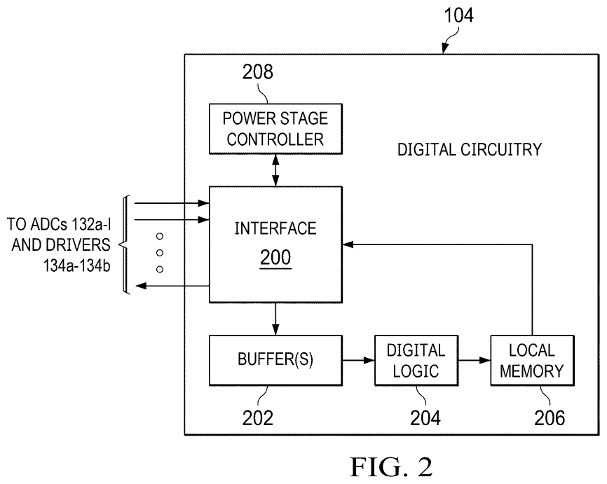

The digital circuitry 104 of FIG. 1 generates signal(s) (e.g., pulse width modulated (PWM) signals) to control the power stage(s) 106 through 108 via the driver(s) 134a through 134b. Additionally, the digital circuitry 104 obtains digital signals corresponding to analog voltages, currents, temperatures, data packets from other components of the system 100, and/or any other signals and/or signals that have been sampled. As further described below, the digital circuitry 104 can determine (e.g., estimate, infer, etc.) various information related to the health of the power stages 106 based on the obtained digital signals so that a user and/or administrator of the load device 122 can predict a failure before it occurs. For example, the digital circuitry 104 can determine an equivalent series inductance of the capacitors 118, a capacitance of the capacitors 118 (e.g., based on a transient event or based on steady state operation), an effective series resistance/impedance of the capacitors 118, an inductance of the inductors 112, a power efficiency of the power stage(s) 106 through 108, an inductor impedance, power stage current leakage, inductor core loss, cooling failures, and/or communication issues (e.g., a number or percentage of malformed or corrupted communication data packets). The digital circuitry 104 can timestamp the obtained telemetry data and/or determine data and transmit the telemetry data, determined data, and/or timestamps to the BMC 130. The digital circuitry 104 includes a number of terminals. The terminals of the digital circuitry 104 are coupled to corresponding ADCs 132l-132l and/or the driver 134a through 134b. The digital circuitry 104 is further coupled to the load device 122 and the BMC 130. The digital circuitry 104 is further described below in conjunction with FIG. 2.

The power stages 106 through 108 of FIG. 1 provide a voltage and/or current corresponding to input PWM signal(s) from the drivers 134a through 134b. The power stages 106 through 108 include transistors and/or buffers/inverters to generate an output voltage based on the amount of time the high side transistor 162, 168 is conducting current versus the amount of time the low side transistor 164, 170 is conducting current. The power stages 106 through 108, each include 6 terminals 152a-152f, 154a-154f. The power stages 106 through 108 include a supply terminal 152f, 154f configured to obtain a supply voltage from the output terminal of the power converter 128. The power stages 106 through 108 also include a ground terminal 152d, 154d coupled to a ground terminal. The power stages 106 through 108 include an input terminal 152b, 154b coupled to the output of the drivers 134a through 134b. An output terminal 152e, 154e of the power stage 106 through 108 is coupled to the corresponding inductor 112 through 114. Additionally, the power stages 106 through 108 include a terminal 152c, 154c to provide output current measurements to the multiphase controller 102. The power stages 106 through 108 also include temperature sensors 160, 166 to measure a temperature on or near the power stages 106 through 108. The sensed temperature is provided to the multiphase controller 102 via a terminal 152a, 154a.

The inductors 112 through 114 of FIG. 1 (e.g., also referred to as inductive devices) charge or discharge based on the output voltage of the respective power stages 106 through 108. Although the example of FIG. 1 includes N inductors (e.g., for the N power stages), there may be any number of inductors. Additionally, although the inductors 112 through 114 are illustrated as single winding inductors, the inductors 112 through 114 can be any type of inductor or inductive device (e.g., coupled inductors, trans-inductor voltage regulator (TLVR), etc.). The inductors 112 through 114 each include a first terminal that is coupled to the output terminal of the respective power stages 106 through 108. The inductors 112 through 114 each include a second terminal that is coupled to the power delivery network 116.

The power delivery network 116 of FIG. 1 is a network and/or circuitry of interconnects in the power supply path from the power stages 106 through 108 to the load device 122. The power delivery network 116 distributes low-noise DC voltage and power to the load device 122, provides a low-noise return path for signals, and/or mitigates electromagnetic interference problems. The power delivery network 116 includes N input terminals and N output terminals (e.g., for the N power stages 106 through 108). The first input terminal of the power delivery network 116 is coupled to the second terminal of the inductor 112. The second input terminal of the power delivery network 116 is coupled to the second terminal of the inductor 114. The first output terminal of the power delivery network 116 is coupled to the first terminals of the capacitors 118 and the board interface 120. The second output terminal of the power delivery network 116 is coupled to the second terminals of the capacitors 118 and the board interface 120.

The capacitors 118 of FIG. 1 charge and/or discharge based on the output of the power delivery network 116. Although the example of FIG. 1 includes three capacitors, there may be a different number of capacitors depending on the desired capacitance. The capacitors 118 each include a first terminal and a second terminal. The first terminals of the capacitors 118 are coupled to the power delivery network 116, the board interface 120, and each other. The second terminals of the capacitors 118 are coupled to the power delivery network 116, the board interface 120 and the other capacitors 118.

The board interface 120 of FIG. 1 is an interface between the load device 122 and the power delivery network 116 and/or controller 102. The board interface 120 includes multiple terminals. For example, a first terminal of the board interface 120 is coupled to the power network and the first terminals of the capacitors 118. A second terminal of the board interface 120 is coupled to the power delivery network 116 and the second terminals of the capacitors 118. A third, fourth, fifth, and sixth terminal of the board interface 120 are each coupled to the load device 122. In some examples, there may be additional terminals of the board interface 120 coupled to the load device 122. A seventh and eight terminal of the board interface 120 are each coupled to the ADCs 132e, 132f of the controller 102.

The cooling system 124 of FIG. 1 is a system of components used to cool or lower the temperature at or near the system 100. The cooling system includes one or more fans, water piping, water pumps, air conditioning units, and/or any other system to cool the system 100.

The power converters 126, 128 of FIG. 1 each convert a first voltage to a second voltage. For example, the power converter 126 can convert an alternating current (AC) voltage to a direct current (DC) voltage. In some examples, the power converter 126 may convert a high voltage DC voltage to a medium voltage (MV) DV voltage. The power converter 126 obtains a supply voltage and converts to a DC or lower DC output voltage to the second power converter 128. The power converter 128 is an intermediate bus converter. The power converter 128 is an efficient, low-profile, isolated, fixed-ratio converter. The power converter 128 converts the output voltage from the first power converter 126 to a different voltage (e.g., the supply voltage for the power stages 106 through 108).

The BMC 130 of FIG. 1 is a remotely monitors the physical state of the system 100. The BMC 130 communicates with the digital circuitry 104 of the controller 102 to obtain collected telemetry data and/or determine data from the digital circuitry 104 and causes the obtained information to be transmitted to another device via the network 136 (e.g., a network communication). Additionally or alternatively, the BMC 130 can output the obtained information into the external storage device 138.

The controller 102 of FIG. 1 includes a plurality of ADCs 132a-132l to collect analog samples of voltages, currents, and/or signals throughout the system 100. For example, the ADC 132a includes a first terminal coupled to a temperature sensor 160, 166 of the power stage 106 and a second terminal to provide a sampled signal from the temperature sensor 160, 166 to the digital circuitry 104. The ADC 132b includes a first terminal coupled to the output terminal of the power stage 106 and a second terminal to provide the sampled output or phase current of the power stage 106 to the digital circuitry 104. The ADC 132c includes a first terminal coupled to a temperature sensor 160, 166 of the power stage 108 and a second terminal to provide a sampled signal from the temperature sensor 160, 166 to the digital circuitry 104. The ADC 132d includes a first terminal coupled to the output terminal of the power stage 108 and a second terminal to provide the sampled output or phase current of the power stage 108 to the digital circuitry 104. The ADC 132e includes a first terminal coupled to the load device 122 via the board interface 120 to obtain a remote sense signal and a second terminal to provide the remote sense signal to the digital circuitry 104. The ADC 132e includes a first terminal coupled to the load device 122 via the board interface 120 to obtain an output voltage and a second terminal to provide the output voltage to the digital circuitry 104. The ADC 132i includes a first terminal coupled to the output terminal of the power converter 126 to obtain the input voltage and a second terminal coupled to the digital circuitry 104 to provide the input voltage to the digital circuitry 104. The ADC 132j includes a first terminal coupled to the output terminal of the power converter 126 to obtain the input current and a second terminal coupled to the digital circuitry 104 to provide the input current to the digital circuitry 104. The ADC 132k includes a first terminal coupled to the output terminal of the power converter 128 to obtain the local input voltage and a second terminal coupled to the digital circuitry 104 to provide the local input voltage to the digital circuitry 104. The ADC 132l includes a first terminal coupled to the output terminal of the power converter 128 to obtain the local input current and a second terminal coupled to the digital circuitry 104 to provide the local input current to the digital circuitry 104. In some examples, the ADCs 132a-132l can be implemented as a smaller number of ADCs with multiplexed channels to sample multiple signals into a small number of ADCs.

FIG. 2 is a block diagram of an example implementation of the digital circuitry 104 of FIG. 1. The digital circuitry 104 includes an example interface 200, example buffer(s) 202, example digital logic 204, example local memory 206, and an example power stage controller 208.

The interface 200 of FIG. 2 routes data from the ADCs 132a-321 to the buffer(s) 202. For example, the interface 200 obtains telemetry data sampled and/or obtained by the ADCs 132a-132l of FIG. 1. Additionally, the interface 200 outputs one or more signals to the drivers 134a through 134b generated by the power stage controller 208. The interface 200 also obtains instructions to adjust control of the power stages 106 through 108 of FIG. 1 based on instructions from the load device 122 of FIG. 1. The interface 200 may be one interface to obtain data and/or transmit data to the multiple ADCs 132a-132l and/or drivers 134a through 134b of FIG. 1 or may include multiple interfaces (e.g., an interface for each ADC 132a-132l and/or driver 134a through 134b of FIG. 1). The interface 200 provides the obtained telemetry data to be stored in the example buffer(s) 202. Additionally, the interface 200 transmits communications and/or instructions from the load device 122 to the power stage controller 208, so that the power stage controller 208 can adjust the state of the power stages 106 through 108 based on instructions from the load device 122.

The buffer(s) 202 of FIG. 2 store obtained samples of the telemetry data from the ADCs 132a-132l. For example, the buffer(s) may be a first-in last-out buffer that stores N number of samples. When a buffer is full and a subsequent sample is obtained, the oldest sample is removed to make room for the newest sample. The buffer(s) 202 may include multiple buffer(s) (e.g., a buffer for each ADC 132-132l) or a single buffer.

The digital logic 204 of FIG. 2 determines different parameters related to the health of the power stages 106 through 108 based on the obtained telemetry data. For example, the digital logic 204 uses obtained voltages, currents, temperatures, data packets, and/or other information obtained by the ADCs 132a-132l to determine an equivalent series inductance of the capacitors 118, a capacitance of the capacitors 118 (e.g., based on a transient event or based on steady state operation), an effective series resistance of the capacitors 118, an inductance of the inductors 112, a power efficiency of the power stage(s) 106 through 108, an inductor impedance, power stage current leakage, and/or communication issues. For example, the digital logic 204 can determine the capacitance of the capacitors 118 during steady-state based on the output current and an output voltage, based on the below Equation 1.

$$Δ {V}_{out ( ripple )} \approx {L}_{ESL} \cdot \frac{{di}_{sum}}{dt} + {R}_{ESR} \cdot {i}_{sum} + \frac{1}{{C}_{out}} {\int }_{}^{} {i}_{sum} \qquad ( Equation 1 )$$

In the above-Equation 1, iₛᵤₘ is a sum of the current samples from the phase currents from the ADCs 132a, 132b over a period of time, Vₒᵤₜ₍ᵣᵢₚₚₗₑ₎ is the amount of voltage ripple when during operation of the power stages 106 through 108, Cₒᵤₜ is the capacitance of the capacitors 118, L_{ESL} is the equivalent series inductance of the capacitors 118, and R_{ESR} is the equivalent series resistance of the capacitors 118. Because the iₛᵤₘ is linear at particular regions diₛᵤₘ/dt can be determined by calculating the slope between two measurements within a linear region of isum L_{ESL} can be determined based on amplitude of the output voltage while the isum is increasing (e.g., while the high side transistor 162, 164 of the corresponding power stage 106 through 108 was enabled to output the supply voltage to charge the capacitors 118), as shown in the below Equation 2.

$${V}_{out ( amplitude \_ charging ) )} = \frac{{L}_{ESL}}{{di}_{sum} / dt} \qquad ( Equation 2 )$$

In the above-Equation 2, iₛᵤₘ is a sum of the current samples from the phase currents from the ADCs 132a, 132b over a period of time, V_{out(amplitude_charging)} is the amplitude of voltage ripple when while the high side transistor(s) 162, 164 of one or more of the power stages 106 through 108 is enabled, and L_{ESL} is the equivalent series inductance of the capacitors 118. Additionally, the digital logic 204 can determine the steady state output capacitance of the capacitors 118 based on the change in amplitude of Vout and iₛᵤₘ while the iₛᵤₘ is decreasing (e.g., while the corresponding power stage 106 through 108 was disengage to 0 V to the capacitors 118), as shown in the below Equations 3 and 4.

$$Δ i = \frac{{T}_{off} \cdot V}{{L}_{ESL}} \qquad ( Equation 3 )$$

$${V}_{out ( amplitude \_ charging ) )} = \frac{Δ {i}_{sum} \cdot {T}_{off}}{{C}_{out}} \qquad ( Equation 4 )$$

In the above-Equations 3 and 4, delta iₛᵤₘ is the change in current while the iₛᵤₘ is decreasing and/or when the low side transistor 164, 170 of the corresponding power stage 106 is enabled, delta t is, delta iₛᵤₘ is the largest sum of the current samples from the phase currents from the ADCs 132a, 132b over a period of time minus the smallest sum of the current samples from the phase currents from the ADCS 132a, 132 over a period of time, V_{out(amplitude_discharging)} is the amplitude of voltage ripple when while the low side transistor(s) 164, 170 of one or more of the power stages 106 through 108 is enabled, Cₒᵤₜ is the capacitance of the capacitors 118, and T_{off} is the amount of time while the iₛᵤₘ is decreasing and/or the amount of time that the low side transistor 164, 170 of the corresponding power stage 106, 108 is enabled to output 0 V to the capacitors 118.

The digital logic 204 can determine the capacitance of the capacitors 118 during transient events (e.g., when the control of one or more of the power stages 106 through 108 changes to output a different output voltage), using the below Equation 5.

$${C}_{out} \approx \frac{Δ {i}_{sum}}{\frac{{dV}_{out}}{dt}} \qquad ( Equation 5 )$$

In the above-Equation 5, Cₒᵤₜ is the capacitance of the capacitors 118, delta iₛᵤₘ is the largest sum of the current samples from the phase currents from the ADCs 132a, 132b over a period of time minus the smallest sum of the current samples from the phase currents from the ADCS 132a, 132 over a period of time, and

$$\frac{{dV}_{out}}{dt}$$

is the derivative of the output voltage of the corresponding power stages 106 through 108. The digital logic 204 can determine the R_{ESR} of the capacitors 118 during transient events, using the below Equation 6.

$${R}_{ESR} \approx \frac{Δ V}{Δ {i}_{out}} \qquad ( Equation 6 )$$

In the above Equation 6, R_{ESR} is the equivalent series resistance of the capacitors 118, delta V is the maximum voltage of the corresponding power stages 106 through 108 minus the minimum output voltage of the corresponding power stages 106 through 108, and delta iₛᵤₘ is the largest output current (e.g., the current into the board interface 120) minus the lowest output current over a period of time corresponding to a transient event. The digital logic 204 can determine the L_{ESL} of the capacitors 118 during transient events, using the below Equation 7.

$${L}_{ESL} \approx \frac{Δ V}{\frac{{di}_{out}}{dt}} \qquad ( Equation 7 )$$

In the above Equation 7, L_{ESL} is the equivalent series inductance of the capacitors 118, delta V is the maximum voltage of the corresponding power stages 106 through 108 minus the minimum output voltage of the corresponding power stages 106 through 108, and diₒᵤₜ/dt is the derivative of the output current (e.g., the current into the board interface 120) over a period of time corresponding to a transient event. In some examples, the iₒᵤₜ current is similar or equivalent to the iₛᵤₘ of the above Equation 1. In some examples, the iₒᵤₜ current may be equal to the iₛᵤₘ of Equation 1 plus an output capacitor current (e.g., which can be derived from the output capacitance of Equation 5. In some examples, the iₒᵤₜ current may be a function of the delta V of Equation 7, delta V of the above equation 7, the dVₒᵤₜ/dt of Equation 5 and the output capacitance of Equation 5

$$( e . g . , Δ {V}_{out} = \frac{{I}_{out}^{2}}{\frac{2 * {dV}_{out} / dt}{{C}_{out}}} ) .$$

The digital logic 204 can determine the output inductance of the inductors 112 based on the input voltage, the output voltage, the tₒₙ time, and the amplitude of the phase current during the ton time, using the below Equation 8.

$$L \approx \frac{( {V}_{in} - {V}_{out} ) \cdot {T}_{on}}{Δ {i}_{phase}} \qquad ( Equation 8 )$$

In the above Equation 8, L is the output inductance, Vin is the input voltage obtained from the ADC 132k, Vout is the output voltage obtained from the ADC 132f, Tₒₙ is the amount of time while the iₛᵤₘ is increasing and/or the amount of time that the high side transistor 162, 164 of the corresponding power stage 106, 108 is enabled to output the Vin to the capacitors 118, and delta iₚₕₐₛₑ is the phase change in current while the phase current is increasing and/or when the high side transistor 162, 164 or the corresponding power stage 106 through 108 is enabled. The digital logic 204 can determine the total impedance across the path from the supply voltage terminal through the power stage and into the load device 122 (e.g., the power distribution network path) based on the phase current, the output voltage, the input voltage and the frequency of the PWM signal used to control the power stage, using the below Equation 9.

$${t}_{on , actual} \approx \frac{{V}_{out} + ( {R}_{DCR} + \sum {R}_{PDN} ) \cdot {i}_{phase}}{{V}_{in} - {R}_{PDN 1} \cdot {i}_{phase}} \cdot {T}_{Sw} \qquad ( Equation 9 )$$

In the above-Equation 9, ton, actual, is the amount of time that the high side transistor 162, 164 of the corresponding power stage 106 through 108 is enabled within a period, ΣR_{PDN} is the impedance across the power distribution network path (e.g., from the supply terminal Vin, through the power stage(s) 106 through 108, inductor(s) 112 through 114, power delivery network 116, output capacitors 118, and/or board interfaced 120), R_{PDN1} is the impedance of an input inductance (e.g., via the connection or a resistor, if used) between the supply terminal and the power stage 106 through 108, R_{DCR} is the inductor impedance of the corresponding inductor 112, 114, T_{sw} is 1/frequency of the PWM signal to control the corresponding power stage 106 through 108, and iₚₕₐₛₑ is the output current of a corresponding power stage 106, 108. Additionally, the digital logic 204 can determine the efficiency of the power stage based on the below equations 10 and 11.

$${T}_{on , ideal} = \frac{{V}_{out}}{{V}_{in}} \cdot {T}_{sw} \qquad ( Equation 10 )$$

$${T}_{on , actual} = \frac{{t}_{on , ideal}}{η} \qquad ( Equation 11 )$$

In the above-Equations 10 and 11, η is the efficiency of the power stage, and t_{on,actual} is the amount of time that the high side transistor 162, 164 of the power stage is conducting current (e.g., operating as a closed switch), and t_{on,actual} is the ideal, initial, and/or intended amount of time that the high side transistor 162, 164 of the power stage should be conducting current (e.g., operating as a closed switch) within a period.

The digital logic 204 can determine the power stage aging and/or power stage leakage in a couple of ways. For example, if the power supply is disabled (e.g., the output voltage is not regulating), the power stage leakage current can be measured directly from the local input current and/or local input voltage via the ADCs 132k, 132l. During regulation (e.g., when the power stages 106 through 108 are operating), the digital logic 204 can determine power stage aging and/or power stage leakage based on the input voltage, output voltage, output current, the input current and the power stage efficiency, as shown below in Equations 12 and 13.

$${i}_{in ( expected )} = \frac{{V}_{out} \cdot {i}_{out}}{{V}_{in} \cdot η} \qquad ( Equation 12 )$$

$${i}_{lkg} = {i}_{in ( actual )} - {i}_{in ( expected )} \qquad ( Equation 13 )$$

In the above Equations 12, 13, η is the efficiency of the power stage, Vout is the output voltage from the ADC 132f, Vin is the input voltage from the ADC 132k, iout is the output current, i_{in(actual)} is the measured input current, and i_{in(expected)} is the expected input current. In some examples, the digital logic 204 normalizes the inferred leakage current with respect to temperature measurements (e.g., obtained via the ADCs 132a, 132c). Additionally, the digital logic 204 can provide information related to cooling system shift or failures by comparing input or output power to power stage temperature (e.g., a cooling system failure can be determined when the power stage temperature increases with stable or decreasing power). For example, the digital logic 204 can determine the input and/or output power and correlate with a temperature measurement via the ADCs 132a, 132c by storing the power measurements in conjunction with the temperature measurements, thereby reflecting a health or status of the cooling system 124. In this manner, a user, administrator, and/or processor can analyze the power/temperature associations to identify deviations from past associations. The digital logic 204 determines the input and/or output power using the below Equations 14 and 15.

$${P}_{out} = {V}_{out} \cdot {i}_{out} \qquad ( Equation 14 )$$

$${P}_{in} = {V}_{in} \cdot {i}_{in} \qquad ( Equation 15 )$$

For any of the above-Equation 1-15, the digital logic 204 can utilize two or more telemetry data samples at different points in time to determine a derivative of a signal and/or a delta of a signal. Additionally, the digital logic 204 can timestamp the when the telemetry data was obtained and/or when the inferred data was determined.

The local memory 206 stores the determined data, telemetry data, and/or timestamps. The digital circuitry 104 may keep the determined data until some point in time. For example, the local memory 206 may store the determined data, telemetry data, and/or timestamps until the data is transmitted to the BMC 130 (e.g., to be transmitted to the network 136 and/or stored in the external storage device 138).

The power stage controller 208 of FIG. 2 obtains instructions from the load device 122 via the interface 200 and generates a signal (e.g., a PWM signal) to be sent to the power stages 106, 108 via the interface 200. The signal output by the power stage controller 208 may be periodic with a first part that corresponds to a logic high value and a second part that corresponds to a logic low value within one period. The duration of the period that is logic high versus the duration of the period that is logic low corresponds to the output voltage output by the corresponding power stage 106 through 108. The power stage controller 208 outputs the signal to the interface 200, which is provided to the drivers 134a through 134b of FIG. 1 to drive the corresponding power stages 106 through 108.

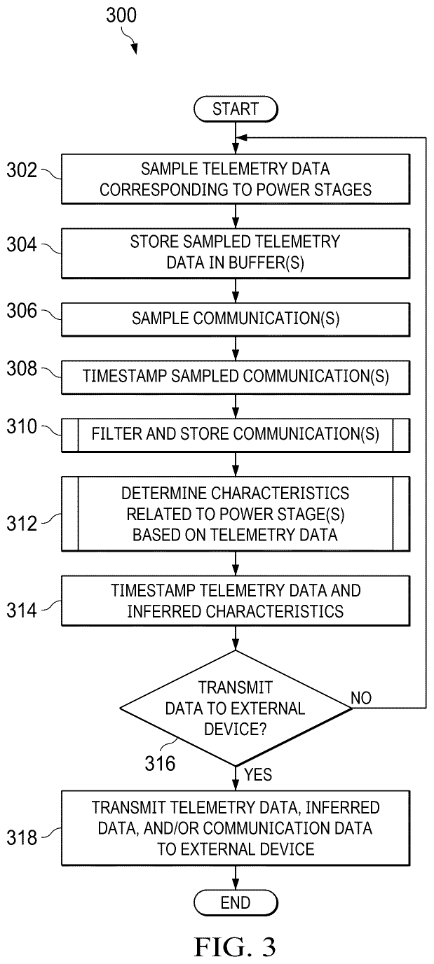

FIG. 3 is a flowchart representative of example machine readable instructions or example operations 300 that may be executed, instantiated, or performed by programmable circuitry and/or by the components of FIGS. 1 and/or 2 to determine information related to the health of the power stages 106 through 108. The example machine readable instructions or example operations 300 may be implemented by the controller 102 of FIG. 1, the digital circuitry 104 of FIG. 2 or by the programmable circuitry platform 1100 of FIG. 11. The example machine-readable instructions or the example operations 300 of FIG. 3 begin at block 302, at which the one or more of the ADCs 132a-132l sample the telemetry data corresponding to the power stages 106 through 108. For example, the one or more of the ADCs 132a-132l can sample and convert an input voltage from the output of the intermediate bus converter 128, an input current from the output of the intermediate bus converter 128, a local input voltage from the output of the intermediate bus converter 128, a local input current from the output of the intermediate bus converter 128, a phase temperature from the temperature sensor(s) 160, 166 of the power stage(s) 105 through 108, an output current from the output of the power stage(s) 106, 108, and/or an output voltage from the load device 122 to digital samples.

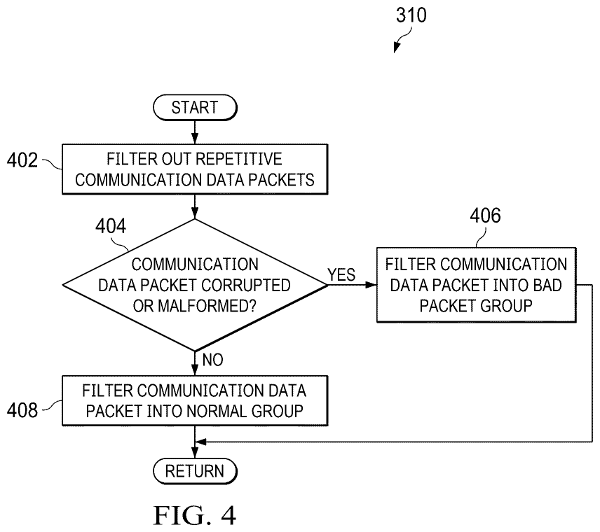

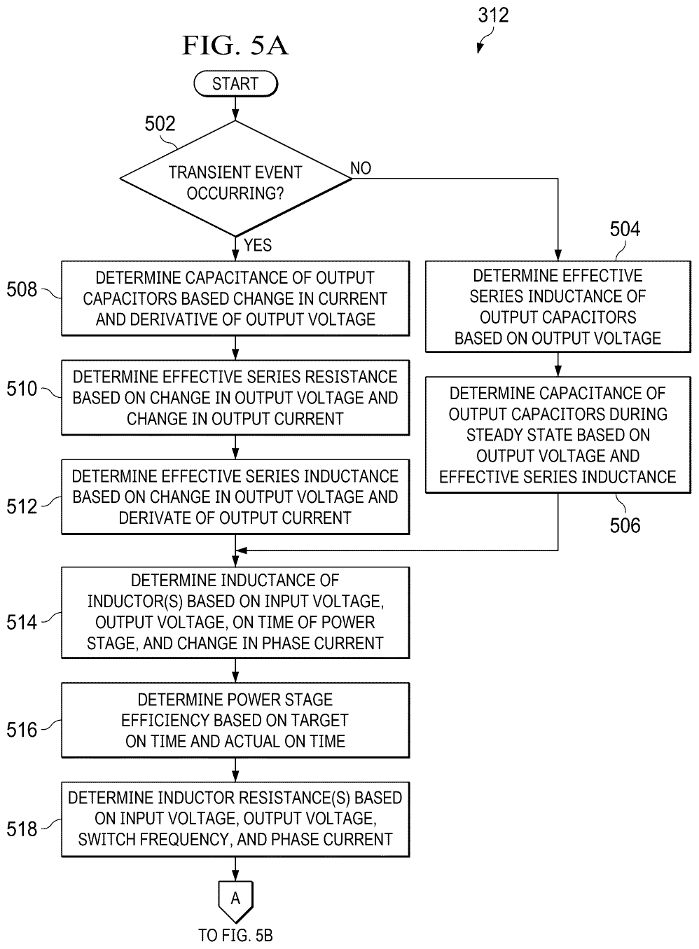

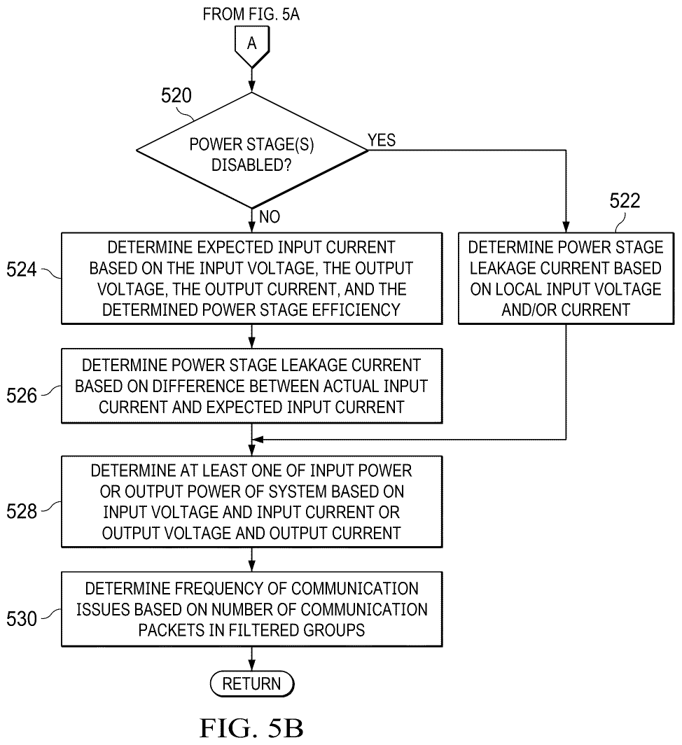

At block 304, the buffer(s) 202 store the digital telemetry data samples. In some examples, the digital telemetry data samples may be stored with a timestamp corresponding to when the digital data samples were obtained. As described above, if the buffer(s) is/are full, the oldest stored sample can be removed and discarded to make room for the newest sample(s). At block 306, the interface 200 samples communication(s) (e.g., data packets sent from the load device 122 of FIG. 1). At block 308, the digital logic 204 timestamps the sampled communication(s). At operation 310, the digital logic 204 filters and stores the communication(s), as further described below in conjunction with FIG. 4. At operation 312, the digital logic 204 determines characteristics related to the power stage(s) (e.g., also referred to as power stage characteristics) based on the telemetry data, as further described below in conjunction with FIGS. 5A-5B. In some examples, block 306-310 may be performed in any order and/or in parallel with other blocks. For example, block 306-310 may be performed before or simultaneously with steps 304-304.

At block 314, the digital logic 204 timestamps the telemetry data and determined characteristics. In some examples, the digital logic 204 stores the telemetry data, determined (e.g., estimated, inferred, etc.) characteristics, communication data, and/or timestamps in the local memory 206 until it is time to transmit the data to an external device (e.g., for storage and/or further analysis). At block 316, the digital logic 204 determines whether to transmit the data to an external device. If the digital logic 204 determines that the data should not be transmitted to an external device (block 316: NO), control returns to block 302 to continue to collect telemetry data samples and determine characteristics related to the power stages 106 through 108. If the interface logic 204 determines that the data should be transmitted to an external device (block 316: YES), the interface 200 transmits the telemetry data, determined data, and/or communication data to BMC 130 via the terminals 150i, 150j to transmit to an external device (e.g., the external storage device 138 and/or another external device via the network 136) (block 318).

FIG. 4 is a flowchart representative of example machine readable instructions or example operations 310 that may be executed, instantiated, or performed by programmable circuitry and/or by the components of FIGS. 1 and/or 2 to filter and store communication data packet(s), as described above in conjunction with block 310 of FIG. 3. The example machine readable instructions or example operations 310 may be implemented by the controller 102 of FIG. 1, the digital circuitry 104 of FIG. 2 or by the programmable circuitry platform 1100 of FIG. 11. The example machine-readable instructions or the example operations 310 of FIG. 4 begin at block 402, at which the digital logic 204 filters out repetitive data packets. For example, the communication data packets may output telemetry data that is repetitive. Accordingly, in some examples, the digital logic 204 may filter out repetitive communication data packets. For example, the digital logic 204 may discard data packets that are the same or substantially similar to previously obtained data packets within a threshold amount of time.

At block 404, the digital logic 204 determines if any of the received data packets from the load device 122 are corrupted or malformed. A communication data packet is corrupted or malformed if the data packet does not correspond to a particular format, has unexpected or inaccurate values, has frame errors, has parity errors, etc. The load device 122 is configured to generate the communication data with a particular format. Accordingly, if a received data packet does not follow the particular format (e.g., corresponds to a different format or includes values that are unexpected, inaccurate, does not make sense, has frame errors, parity errors, etc.), the interface logic 204 determines that the communication packet is corrupted or malformed.

If the digital logic 204 determines that the communication data packet is corrupted or malformed (block 404: YES), the interface logic 204 filters the communication packet into a bad packet group (block 406). The bad packet group that identifies that the communication packet is corrupted or malformed. If the digital logic 204 determines that the communication data packet is not corrupted or malformed (block 404: NO), the digital logic 204 filters the communication data packet into a normal group (block 408). As further described below, the digital logic 204 can generate a ratio or percentage of normal data packets to bad data packets.

FIGS. 5A, 5B illustrate a flowchart representative of example machine readable instructions or example operations 312 that may be executed, instantiated, or performed by programmable circuitry and/or by the components of FIGS. 1 and/or 2 to determine characteristics related to the power stage(s) based on the telemetry data. The example machine readable instructions or example operations 312 may be implemented by the controller 102 of FIG. 1, the digital circuitry 104 of FIG. 2 or by the programmable circuitry platform 1100 of FIG. 11. The example machine-readable instructions or the example operations 312 of FIG. 5A begin at block 502, at which the digital logic 204 determines if a transient event is occurring. For example, the digital logic 204 may obtain a communication packet from the load device 122 to change the regulated voltage (e.g., the load device 122 may request the power stage to increase or lower the output voltage).

If the digital logic 204 determines that a transient event is not occurring (block 502: YES), control continues to block 508. If the digital logic 204 determines that the transient event is not occurring (block 502: NO), the digital logic 204 determines the equivalent series inductance of the capacitors 118 based on the output voltage (block 504). For example, the interface logic 204 uses the above-Equation 2 to determine the determined series inductance of the capacitors 118. At block 506, the digital logic 204 determines the capacitance of the capacitors 118 during steady state based on the output voltage and the equivalent series inductance using the above-Equation 1. In some examples, the digital logic 204 can determine the capacitance of the capacitors 118 during steady state based on the output voltage using the above-Equations 3 and/or 4.

At block 508, the digital logic 204 determines the capacitance of the capacitors 118 based on change in current and the derivative of the output voltage using the above-Equation 5. At block 510, the digital logic 204 determines the effective series resistance of the capacitors 118 based on the change in output voltage and the change in output current using the above-Equation 6. At block 512, the digital logic 204 determines the equivalent series inductance based on the change in the output voltage and a derivative of the output current using the above-Equation 7.

At block 514, the digital logic 204 determines the inductance of the inductor(s) 112 through 114 based on the input voltage, the output voltage, the on time of the corresponding power stage 106 through 108, and the change in phase current using the above-Equation 8. At block 516, the digital logic 204 determines the power stage efficiency based on the target on time and the actual on time using the above-Equations 10 and 11. At block 518, the digital logic 204 determines the inductor impedance(s) based on the input voltage, output voltage, switch frequency, and phase current using the above-Equation 9.

At block 520 of FIG. 5B, the digital logic 204 determines if the power stage(s) 106, 108 are disabled (e.g., not regulating the input voltage). For example, the digital logic 204 may obtain instructions for the power stage(s) 106, 108 to not regulate the input voltage from the load device 122. If the digital logic 204 determines that the power stage(s) are disabled (block 520: YES), the digital logic 204 determines the power stage leakage current based on the local input voltage and/or current (block 522). If the digital logic 204 determines that the power stage is not disabled (block 520: NO), the digital logic 204 determines the expected input current based on the input voltage, the output voltage, the output current, and the determined power stage efficiency using the above-Equation 12 (block 524). At block 526, the example digital logic 204 determines the power stage leakage current based on the difference between the actual input current and the expected input current, using the above-Equation 13.

At block 528, the digital logic 204 determines at least one of input power or output power of the system based on (a) an input voltage and an input current or (b) an output voltage and an output current using one or more of the above-Equations 12 and 15. As described above, the input and/or output power can be associated with temperature measurements to determine the health and/or status of the cooling systems 124. At block 530, the interface logic 204 determines the frequency of communication issues based on the number of communication packets in the filtered groups. For example, the interface logic 204 may determine a frequency of communication problems based on the number of communication packets filtered into the bad group and a number of data packets filtered into the normal group, as described above in conjunction with FIG. 4.

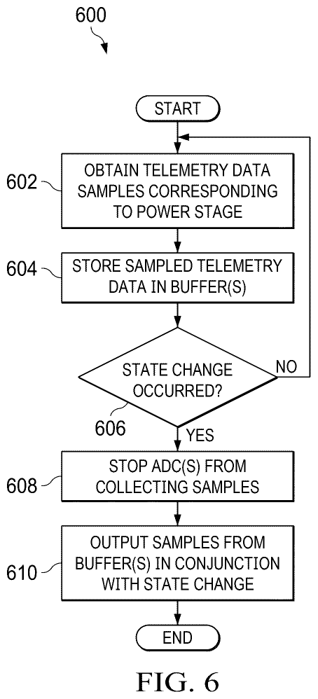

FIG. 6 is a flowchart representative of example machine readable instructions or example operations 600 that may be executed, instantiated, or performed by programmable circuitry and/or by the components of FIGS. 1 and/or 2 to output historical telemetry data in response to a state change. A state change is an adjustment of the control of the power stage(s) (e.g., change the output voltage, stop regulating, start regulating, etc.). The example machine readable instructions or example operations 600 may be implemented by the controller 102 of FIG. 1, the digital circuitry 104 of FIG. 2 or by the programmable circuitry platform 1100 of FIG. 11. The example machine-readable instructions or the example operations 600 of FIG. 6 begin at block 602, at which the interface 200 obtains telemetry data samples corresponding to the power stage from the ADCs 132a-132l. For example, the ADCs 132a-132l obtains an analog signal, voltage, and/or current and converts the analog sample into a digital sample.

At block 604, the example ADCs 132a-132l store the digital samples of the telemetry data in the example buffer(s) 202. At block 606, the digital logic 204 determines if a state change has occurred. As described above, a state change occurs when the digital circuitry 104 obtains instructions to change control of one or more of the power stages. If the digital logic 204 determines that a state change has not occurred (block 606: NO), control returns to block 602 to continue to obtain and store telemetry data samples. If the digital logic 204 determines that a state change has occurred (block 606: YES), the digital logic 204 stops the ADCs from collecting additional samples. In this manner, the buffer(s) 202 store data corresponding to a brief look into the history of the system before the state change was triggered (block 608). This information may be valuable to a person tracking the health of the system, because the state change may have been triggered due to an issue. At block 610, the interface 200 outputs the samples in the buffer (e.g., the telemetry samples collected prior to the state change), to the BMC 130 to be transmitted to the network 136 and/or the external storage device 138 via a network communication. In this manner, the telemetry data can be stored and/or processed externally to determine if there is an issue with the power stages 106 through 108 and/or any other part of the system 100.

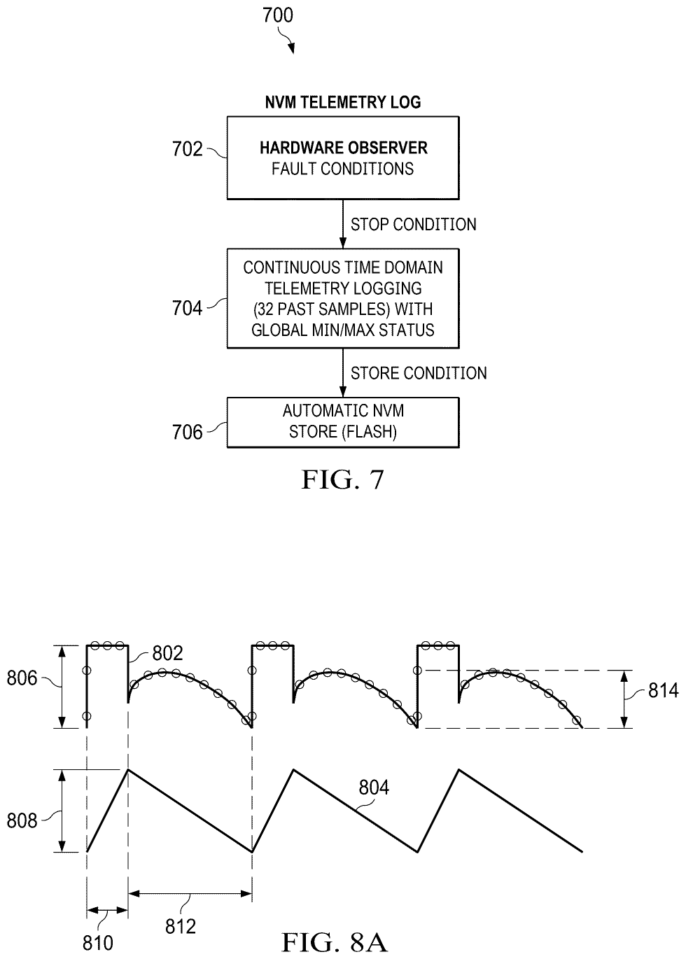

FIG. 7 illustrates an example flowchart 700 corresponding to a change in state of the system 100. At block 702, the digital circuitry 104 observes telemetry data from hardware by obtaining analog telemetry data from the 10 ADC channels of FIG. 1, converting the data samples to digital telemetry data samples, and storing the digital telemetry data samples in buffers. In response to a state change (e.g., a stop condition, a start condition, a change in the output voltage, etc.), the hardware observation will cease. There can be any number of state changes (e.g., configurable triggers) that result in ceasing the hardware observation. Thus, the buffers will store a continuous time domain telemetry logging with N number of sample taken before the state change was identified (block 704). The state change is followed by a store condition (e.g., a trigger to transmit and/or store determined and/or sampled data to/in an external device) to cause the data in the telemetry buffers to be automatically transmitted to the network 132 and/or the storage 134 for storage and/or analysis (block 706).

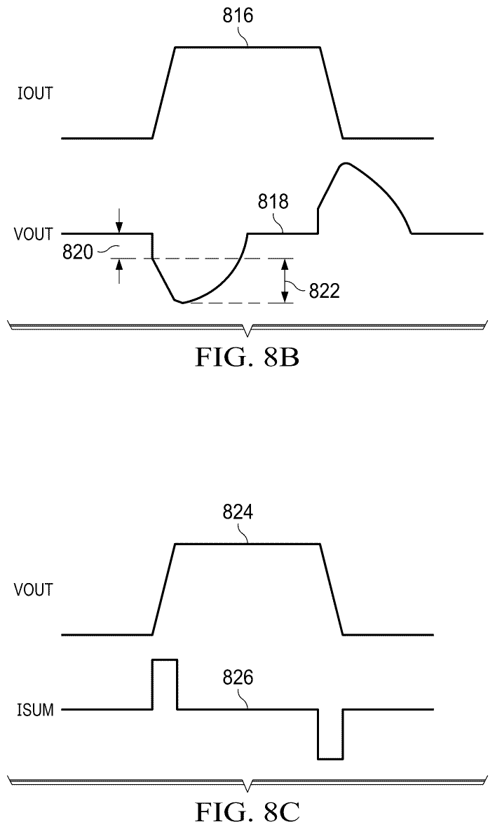

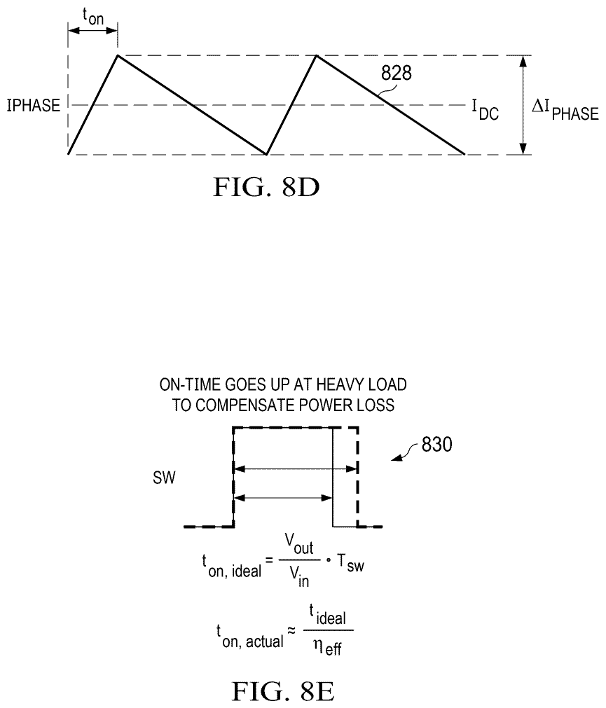

FIGS. 8A-8E illustrate example telemetry data plots that correspond to the above-Equations 1-15. FIG. 8A includes an example output voltage 802, an example current sum 804, a first example output voltage amplitude 806 (e.g., while the current sum increase), an example current sum amplitude 808, an example current increase duration 810, an example current decrease duration 812, and a second example output voltage amplitude 808 (e.g., while the current sum decreases). The output voltage 802 of FIG. 1 corresponds to the output voltage provided by the load device 122 via the ADC 132f of FIG. 1. The current sum 804 corresponds to a sum of the output currents of the power stages 106-108 via the ADCs 132b, 132d.

The first output voltage amplitude 806 of the output voltage 802 corresponds to the V_{out(amplitude_charging)} of the above-Equation 2 and the change of amplitude 808 divided by the current increase duration 810 corresponds to the diₛᵤₘ/dt of Equation 2. Accordingly, the output voltage 802 and the current sum 804 can be used do determine the L_{ESL} of Equation 2. Likewise, the second output voltage amplitude 814 of the output voltage 802 corresponds to the V_{out(amplitude_discharging)} of the above-Equation 4 and the current decrease duration 812 corresponds to the T_{off} of Equation 4. Accordingly, the output voltage 802 and the current sum 804 can be used to determine the output capacitance of the capacitors 118. Also, the output voltage 802 and the current sum 804 can be used to determine the output capacitance using Equation 1 and Equation 2.

FIG. 8B includes an example output current signal 816, an example output voltage signal 818 and example changes in voltage 820, 822 during a load transient. The current signal 816 corresponds to the output current into the board interface 120. The output voltage signal 818 is obtained from the load device 122 via the ADC 132f. The example change in voltage 820 corresponds to the ΔV of the above-Equation 7. The change in voltage 822 corresponds to the ΔV of the above-Equation 6 and the amplitude of the current signal 816 corresponds to the ΔIout of the above-Equation 6. Additionally, the example change in voltage 820 corresponds to the ΔV of the above-Equation 7 and the slope of the current signal 816 when increasing from the first current to the second current corresponds to the

$$\frac{{di}_{out}}{dt}$$

of the above-Equation 7. Thus, the output voltage and the output current can be used to determine the equivalent series inductance of the capacitors 118.

FIG. 8C includes an example output voltage signal 824 and an example current sum signal 826 during a voltage transient. The output voltage signal 824 is obtained from the load device 122 via the ADC 132f. The current sum signal 826 corresponds to a sum of the output currents of the power stages 106-108 via the ADCs 132b, 132d. In FIG. 8C, the slope of the output voltage signal 824 from the first voltage to the second voltage corresponds to the

$$\frac{{dV}_{out}}{dt}$$

of the above-Equation 5. Additionally, the amplitude of the current sum signal 826 corresponds to the Δiₛᵤₘ of the above-Equation 5. Accordingly, the current sum signal 826 and the output voltage signal 824 can be used to determine the capacitance of the capacitors 118.

FIG. 8D illustrates an example phase current signal 828. The phase current signal 828 corresponds to the current obtained from the output of one of the power stages 106 through 108 via one of the ADCs 132b, 132d. In FIG. 8D, the amplitude of the phase current signal 828 corresponds to the Δiₚₕₐₛₑ of above-Equation 8. Additionally, the amount of time when the phase current signal 828 is increasing corresponds to the tₒₙ of the above Equation 8. Accordingly, the phase current signal 828 can be used to determine the inductance of the inductors 112.

FIG. 8E illustrates an example portion of a control signal (e.g., a PWM signal) 830 used to control one or more of the power stage(s) 106 through 108 of FIG. 1. The control signal 830 corresponds to one of the signals about by one of the drivers 134a, 134b. When the control signal 830 is high, the high side transistor 162, 164 of the corresponding power stage 106 through 108 is enabled to output the supply voltage at the output terminal. When the control signal 830 is low, the low side transistor 164, 170 of the corresponding power stage 106 through 108 is enabled to output a 0 V at the output terminal. For larger loads, the on-time (e.g., the duration that the control signal 830 is a high voltage), increases to compensate for power loss. The duration that the control signal 830 is high corresponds to the T_{SW} of the above-Equations 9 and 10. Thus, the duration of time that the control signal 830 is high can be used to determine the impedance across the power distribution network path and/or the efficiency of the power stage, as further described above.

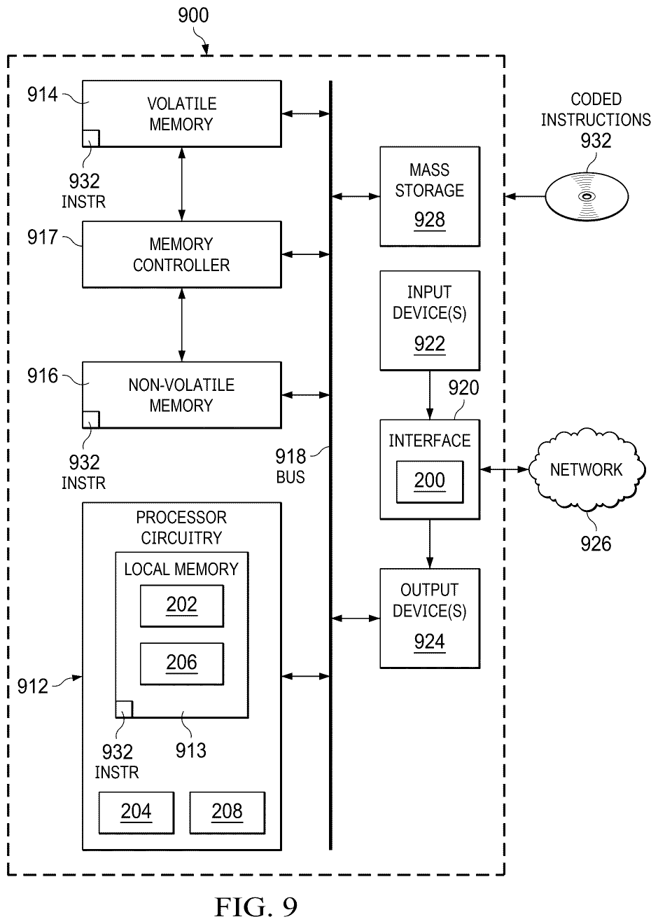

FIG. 9 is a block diagram of an example programmable circuitry platform 900 structured to execute or instantiate the example machine-readable instructions or the example operations of FIGS. 3-7 to implement the controller 102 and/or digital circuitry 104 of FIGS. 1 and/or 2. The programmable circuitry platform 900 can be, for example, a server, a controller, a microcontroller, a computer, a self-learning machine (e.g., a neural network), or any other type of computing or electronic device.

The programmable circuitry platform 900 of the illustrated example includes programmable circuitry 912. The programmable circuitry 912 of the illustrated example is hardware. For example, the programmable circuitry 912 can be implemented by one or more integrated circuits, logic circuits, FPGAs, microprocessors, CPUs, GPUs, DSPs, or microcontrollers from any desired family or manufacturer. The programmable circuitry 912 may be implemented by one or more semiconductor based (e.g., silicon based) devices. In this example, the programmable circuitry 912 implements the digital logic 204 and/or the power stage controller 208 of FIG. 2. However, the programmable circuitry 912 can additionally or alternatively be used to implement any portion of the controller 102 and/or BMC 130 of FIG. 1.

The programmable circuitry 912 of the illustrated example includes a local memory 913 (e.g., a cache, registers, etc.). In the example of FIG. 9, the local memory 913 implements the buffer(s) 202 and/or the local memory 206 of FIG. 2. The programmable circuitry 912 of the illustrated example is in communication with main memory 914, 916, which includes a volatile memory 914 and a non-volatile memory 916, by a bus 918. The volatile memory 914 may be implemented by Synchronous Dynamic Random Access Memory (SDRAM), Dynamic Random Access Memory (DRAM), RAMBUS® Dynamic Random Access Memory (RDRAM®), or any other type of RAM device. The non-volatile memory 916 may be implemented by flash memory or any other desired type of memory device. Access to the main memory 914, 916 of the illustrated examples is controlled by a memory controller 917. In some examples, the memory controller 917 may be implemented by one or more integrated circuits, logic circuits, microcontrollers from any desired family or manufacturer, or any other type of circuitry to manage the flow of data going to and from the main memory 914, 916.

The programmable circuitry platform 900 of the illustrated example also includes interface circuitry 920. The interface circuitry 920 may be implemented by hardware in any type of interface standard, such as an Ethernet interface, a universal serial bus (USB) interface, a Bluetooth® interface, a near field communication (NFC) interface, a Peripheral Component Interconnect (PCI) interface, or a Peripheral Component Interconnect Express (PCIe) interface. In the example of FIG. 9, the interface circuitry 920 includes the example interface 200 of FIG. 2.

In the illustrated example, one or more input devices 922 are connected to the interface circuitry 920. The input device(s) 922 permit(s) a user (e.g., a human user, a machine user, etc.) to enter data or commands into the programmable circuitry 912. The input device(s) 922 can be implemented by, for example, an audio sensor, a microphone, a camera (still or video), a keyboard, a button, a mouse, a touchscreen, or a voice recognition system.

One or more output devices 924 are also connected to the interface circuitry 920 of the illustrated example. The output device(s) 924 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, or speaker. The interface circuitry 920 of the illustrated example, thus, typically includes a graphics driver card, a graphics driver chip, or graphics processor circuitry such as a GPU.

The interface circuitry 920 of the illustrated example also includes a communication device such as a transmitter, a receiver, a transceiver, a modem, a residential gateway, a wireless access point, or a network interface to facilitate exchange of data with external machines (e.g., computing devices of any kind) by a network 926. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 900 of the illustrated example also includes one or more mass storage discs or devices 928 to store firmware, software, or data. Examples of such mass storage discs or devices 928 include magnetic storage devices (e.g., floppy disk, drives, HDDs, etc.), optical storage devices (e.g., Blu-ray disks, CDs, DVDs, etc.), RAID systems, or solid-state storage discs or devices such as flash memory devices or SSDs.

The machine readable instructions 932, which may be implemented by the machine readable instructions of FIGS. 3-7, may be stored in the mass storage device 928, in the volatile memory 914, in the non-volatile memory 916, or on at least one non-transitory computer readable storage medium such as a CD or DVD which may be removable.

While an example manner of implementing the digital circuitry 104 of FIG. 1 is illustrated in FIG. 2, one or more of the elements, processes, or devices illustrated in FIG. 2 may be combined, divided, re-arranged, omitted, eliminated, or implemented in any other way. Further, any one or more of the components of FIGS. 1 and/or 2 may be implemented by hardware alone or by hardware in combination with software and firmware. Thus, for example, any one or more of the components of FIGS. 1 and/or 2, could be implemented by programmable circuitry in combination with one or more machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), or field programmable logic device(s) (FPLD(s)) such as FPGAs. Further still, the example controller 102 and/or digital circuitry 104 of FIGS. 1 and/or 2 may include one or more elements, processes, or devices in addition to, or instead of, those illustrated in FIGS. 1 and/or 2, or may include more than one of any or all of the illustrated elements, processes and devices.

Flowchart(s) representative of example machine-readable instructions, which may be executed by programmable circuitry to at least one of implement or instantiate the controller 102 and/or the digital circuitry 104 or representative of example operations which may be performed by programmable circuitry to at least one of implement or instantiate the controller 102 and/or the digital circuitry 104. The machine-readable instructions may be one or more executable programs or portion(s) of one or more executable programs for execution by programmable circuitry such as the programmable circuitry 912 shown in the example processor platform 900 discussed below in connection with FIG. 9 and may be one or more function(s) or portion(s) of functions to be performed by the example programmable circuitry (e.g., an FPGA). In some examples, the machine-readable instructions cause an operation, a task, etc., to be carried out or performed in an automated manner in the real-world. As used herein, “automated” means without human involvement.

The program may be embodied in instructions (e.g., software or firmware) stored on one or more non-transitory computer readable or machine-readable storage medium such as one of or a combination of cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), or any other storage device or storage disk. The instructions of the non-transitory computer readable or machine-readable medium may program or be executed by programmable circuitry located in one or more hardware devices, but the entire program or parts thereof could alternatively be executed or instantiated by one or more hardware devices other than the programmable circuitry or embodied in dedicated hardware. The machine-readable instructions may be distributed across multiple hardware devices or executed by two or more hardware devices (e.g., a server and a client hardware device). For example, the client hardware device may be implemented by an endpoint client hardware device (e.g., a hardware device associated with a human or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 3-7, many other methods of implementing the example system 100 may alternatively be used. For example, the order of execution of the blocks of the flowchart(s) may be changed, or some of the blocks described may be changed, eliminated, or combined. Also or alternatively, any or all of the blocks of the flow chart may be implemented by one or more hardware circuits (e.g., processor circuitry, discrete, integrated analog or digital circuitry, an FPGA, an ASIC, a comparator, an operational-amplifier (op-amp), a logic circuit, etc.) structured to perform the corresponding operation without executing software or firmware. The programmable circuitry may be distributed in different network locations or local to one or more hardware devices (e.g., a single-core processor (e.g., a single core CPU), a multi-core processor (e.g., a multi-core CPU, an XPU, etc.)). For example, the programmable circuitry may be one of or a combination of a CPU or an FPGA located in the same package (e.g., the same integrated circuit (IC) package or in two or more separate housings), one or more processors in a single machine, multiple processors distributed across multiple servers of a server rack, multiple processors distributed across one or more server racks, etc., or any combination(s) thereof.

The machine-readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, or produce machine executable instructions. For example, the machine-readable instructions may be fragmented and stored on one or more storage devices, disks or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, or executable by a computing device or other machine. For example, the machine-readable instructions may be stored in multiple parts, which are individually compressed, encrypted, or stored on separate computing devices, wherein the parts if decrypted, decompressed, or combined form a set of one or more computer-executable or machine executable instructions that implement one or more functions or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions or the corresponding program(s) can be executed in whole or in part. Thus, machine-readable, computer readable or machine-readable media, as used herein, may include one or a combination of instructions and program(s) regardless of the particular format or state of the machine-readable instructions or program(s).

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 3-7 may be implemented using executable instructions (e.g., computer readable or machine-readable instructions) stored on one or more non-transitory computer readable or machine-readable media. As used herein, the terms non-transitory computer readable medium, non-transitory computer readable storage medium, non-transitory machine-readable medium, and non-transitory machine-readable storage medium are expressly defined to include any type of computer readable storage device or storage disk and to exclude propagating signals and to exclude transmission media. Examples of such non-transitory computer readable medium, non-transitory computer readable storage medium, non-transitory machine-readable medium, or non-transitory machine-readable storage medium include one or more optical storage devices, magnetic storage devices, an HDD, a flash memory, a read-only memory (ROM), a CD, a DVD, a cache, a RAM of any type, a register, or any other storage device or storage disk in which information is stored for any duration (e.g., for extended time periods, permanently, for brief instances, for temporarily buffering, for caching of the information). As used herein, the terms “non-transitory computer readable storage device” and “non-transitory machine-readable storage device” are defined to include any physical (mechanical, magnetic, electromechanical, or electrical) hardware to retain information for a time period, but to exclude propagating signals and to exclude transmission media. Examples of non-transitory computer readable storage devices or non-transitory machine-readable storage devices include one or a combination of random-access memory of any type, read only memory of any type, solid state memory, flash memory, optical discs, magnetic disks, disk drives, or redundant array of independent disks (RAID) systems. As used herein, the term “device” refers to physical structure such as one of or a combination of mechanical, electromechanical, or electrical equipment, hardware, or circuitry that may or may not be configured by computer readable instructions, machine-readable instructions, etc., or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, additional elements, terms, etc., may be present without falling outside the scope of the corresponding claim or recitation. As used herein, if the phrase “at least” is used as the transition term in, for example, a preamble of a claim, it is open-ended in the same manner as the term “comprising” and “including” are open ended. The term “or” if used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and things, the phrase “at least one of A and B” refers to implementations including any of (1) at least one A, (2) at least one B, or (3) at least one A and at least one B. Similarly, as used herein in the context of describing structures, components, items, objects and things, the phrase “at least one of A or B” refers to implementations including any of (1) at least one A, (2) at least one B, or (3) at least one A and at least one B. As used herein in the context of describing the performance or execution of processes, instructions, actions, activities, etc., the phrase “at least one of A and B” refers to implementations including any of (1) at least one A, (2) at least one B, or (3) at least one A and at least one B. Similarly, as used herein in the context of describing the performance or execution of processes, instructions, actions, activities, etc., the phrase “at least one of A or B” refers to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or actions may be implemented by, e.g., the same entity or object. Also, although individual features may be included in different examples or claims, these may possibly be combined, and the inclusion in different examples or claims does not imply that a combination of features is at least one of not feasible or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part if the first part is closer to the Earth than the second part. As noted above, a first part can be above or below a second part with one or more of: other parts therebetween, without other parts therebetween, with the first and second parts touching, or without the first and second parts being in direct contact with one another.

As used herein, connection references (e.g., attached, coupled, connected, and joined) may include intermediate members between the elements referenced by at least one of the connection reference or relative movement between those elements unless otherwise indicated. As such, connection references do not necessarily infer that two elements are directly connected or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, or ordering in any way, but are merely used as at least one of labels or arbitrary names to distinguish elements for ease of understanding the described examples. In some examples, the descriptor “first” may be used to refer to an element in the detailed description, while the same element may be referred to in a claim with a different descriptor such as “second” or “third.” In such instances, such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to at least one of manufacturing tolerances or other real-world imperfections. For example, “approximately” and “about” may indicate such dimensions may be within a tolerance range of +/−10% unless otherwise specified herein.

As used herein, the phrase “in communication,” including variations thereof, encompasses one of or a combination of direct communication or indirect communication through one or more intermediary components, and does not require direct physical (e.g., wired) communication or constant communication, but rather also includes selective communication at least one of periodic intervals, scheduled intervals, aperiodic intervals, or one-time events.

As used herein, “programmable circuitry” is defined to include at least one of (i) one or more special purpose electrical circuits (e.g., an application specific circuit (ASIC)) structured to perform specific operation(s) and including one or more semiconductor-based logic devices (e.g., electrical hardware implemented by one or more transistors), or (ii) one or more general purpose semiconductor-based electrical circuits programmable with instructions to perform one or more specific functions(s) or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations or functions, Field Programmable Gate Arrays (FPGAs) that may be programmed with second instructions to at least one of configure or structure the FPGAs to instantiate one or more operations or functions corresponding to the first instructions, Graphics Processor Units (GPUs) that may execute first instructions to perform one or more operations or functions, Digital Signal Processors (DSPs) that may execute first instructions to perform one or more operations or functions, XPUs, Network Processing Units (NPUs) one or more microcontrollers that may execute first instructions to perform one or more operations or functions or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., at least one of programmed or hardwired) at a time of manufacturing by a manufacturer to at least one of perform the function or be configurable (or re-configurable) by a user after manufacturing to perform the function/or other additional or alternative functions. The configuring may be through at least one of firmware or software programming of the device, through at least one of a construction or layout of hardware components and interconnections of the device, or a combination thereof.

As used herein, the terms “terminal,” “node,” “interconnection,” “pin” and “lead” are used interchangeably. Unless specifically stated to the contrary, these terms are generally used to mean an interconnection between or a terminus of a device element, a circuit element, an integrated circuit, a device or other electronics or semiconductor component.

In the description and claims, described “circuitry” may include one or more circuits. A circuit or device that is described herein as including certain components may instead be adapted to be coupled to those components to form the described circuitry or device. For example, a structure described as including one or more semiconductor elements (such as transistors), one or more passive elements (such as one of or a combination of resistors, capacitors, or inductors), or one or more sources (such as voltage or current sources) may instead include only the semiconductor elements within a single physical device (e.g., at least one of a semiconductor die or integrated circuit (IC) package) and may be adapted to be coupled to at least some of the passive elements or the sources to form the described structure either at a time of manufacture or after a time of manufacture, for example, by at least one of an end-user or a third-party.

Circuits described herein are reconfigurable to include the replaced components to provide functionality at least partially similar to functionality available prior to the component replacement. Components shown as resistors, unless otherwise stated, are generally representative of any one or more elements coupled in at least one of series or parallel to provide an amount of impedance represented by the shown resistor. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor. While certain elements of the described examples are included in an integrated circuit and other elements are external to the integrated circuit, in other examples, additional or fewer features may be incorporated into the integrated circuit. In addition, some or all of the features illustrated as being external to the integrated circuit may be included in the integrated circuit and some features illustrated as being internal to the integrated circuit may be incorporated outside of the integrated. As used herein, the term “integrated circuit” means one or more circuits that are at least one of: (i) incorporated in/over a semiconductor substrate; (ii) incorporated in a single semiconductor package; (iii) incorporated into the same module; or (iv) incorporated in/on the same printed circuit board.

Uses of the phrase “ground” in the foregoing description include at least one of a chassis ground, an Earth ground, a floating ground, a virtual ground, a digital ground, a common ground, or any other form of ground connection applicable to, or suitable for, the teachings of this description. Unless otherwise stated, “about,” “approximately,” or “substantially” preceding a value means+/−10 percent of the stated value, or, if the value is zero, a reasonable range of values around zero.

Example methods, apparatus, systems, and articles of manufacture to determine power stage information using telemetry data are described herein. Further examples and combinations thereof include the following: Example 1 includes an apparatus comprising a power stage configured to output a voltage, and a controller configured to drive the power stage, receive telemetry data related to the power stage, determine information related to the power stage based on the telemetry data, and transmit the determined information via a network communication.

Example 2 includes the apparatus of example 1, wherein the telemetry data comprises an input current of the power stage, an output current of the power stage, an input voltage of the power stage, an output voltage of the power stage, a temperature of the power stage, or communication data packets.

Example 3 includes the apparatus of example 1, further including an inductive device and a capacitor coupled between a load device and the power stage.

Example 4 includes the apparatus of example 3, wherein the information comprises a capacitance of the capacitor, an equivalent series inductance of the capacitor, an effective series resistance of the capacitor, an output inductance of the inductive device, a impedance of the inductive device, a impedance of a power distribution network path, an efficiency of the power stage, a leakage current of the power stage, an output power, a timestamp, inductor core loss, cooling failures, or a communication issue.

Example 5 includes the apparatus of example 1, wherein the controller includes an analog-to-digital converter configured to convert the received telemetry data into digital data, the controller configured to determine the information based on the digital data.

Example 6 includes the apparatus of example 1, wherein the controller is a first controller, and the first controller is configured to output the determined information to a second controller to transmit the determined information to an external storage device.

Example 7 includes the apparatus of example 1, wherein the controller is configured to identify a number of malformed communication packets.

Example 8 includes the apparatus of example 1, wherein the controller includes a buffer configured to store a number of samples of the telemetry data.

Example 9 includes the apparatus of example 8, wherein the controller is configured to identify a state change based on an instruction to adjust operation of the power stage, based on the state change, stop sampling of the telemetry data, and transmit the number of samples in the buffer to an external device.

Example 10 includes a method comprising receiving, by a controller, analog telemetry power stage data, converting, by an analog-to-digital (ADC) converter of the controller, the analog power stage telemetry data to digital telemetry data, determining, by digital circuitry of the controller, a power stage characteristic based on the digital telemetry data, and transmitting, by the controller, the power stage characteristic.

Example 11 includes the method of example 10, wherein the analog power stage telemetry data includes at least one of a power stage input current, a power stage output current, a power stage input voltage, a power stage output voltage, a power stage temperature, or communication data packets.

Example 12 includes the method of example 10, wherein the power stage characteristic includes at least one of a capacitance of a capacitor connected to a load device, an equivalent series inductance of the capacitor, an effective series resistance of the capacitor, an output inductance of an inductive device coupled to the power stage, a impedance of the inductive device, an on impedance of a power distribution network path, an efficiency of the power stage, a leakage current of the power stage, an output power, or a communication issue.

Example 13 includes the method of example 10, further including identifying a number of malformed communication packets from a load device, and transmitting information corresponding to the number of malformed communication packets.

Example 14 includes the method of example 10, further including storing the digital telemetry data into a buffer.

Example 15 includes the method of example 14, further including identifying a state change, based on the state change, stopping the converting of the analog power stage telemetry data to the digital telemetry data, and transmitting the stored digital telemetry data in the buffer.

Example 16 includes an apparatus comprising a driver including an input terminal and an output terminal, the output terminal of the driver structured adapted to be coupled to a power stage, a first analog-to-digital converter including an input terminal and an output terminal, the input terminal of the first analog-to-digital converter structured adapted to be coupled to at least one of a terminal of a power converter, a terminal of the power stage, or a terminal of a load device, a second analog-to-digital converter including an input terminal and an output terminal, the input terminal of the second analog-to-digital converter structured adapted to be coupled to at least one of the terminal of the power converter, the terminal of the power stage, or the terminal of the load device, and digital circuitry including an output terminal, a first input terminal, and a second input terminal, the output terminal of the digital circuitry coupled to the input terminal of the driver, the first input terminal of the digital circuitry coupled to the output terminal of the first analog-to-digital converter, the second input terminal of the digital circuitry coupled to the output terminal of the second analog-to-digital converter.

Example 17 includes the apparatus of example 16, wherein the first analog-to-digital converter structured adapted to be coupled to a supply voltage terminal of the power stage, and the second analog-to-digital converter structured adapted to be coupled to the load device via an interface.

Example 18 includes the apparatus of example 16, wherein the first analog-to-digital converter is structured to be coupled to an output terminal of the power stage.

Example 19 includes the apparatus of example 16, wherein the first analog-to-digital converter is coupled to a temperature sensor of the power stage. the apparatus of example 16, further including a third analog-to-digital converter including a first terminal and a second terminal, the first terminal of the third analog-to-digital converter coupled to the digital circuitry, the second terminal of the third analog-to-digital converter coupled to a board management controller.

Modifications are possible in the described examples, and other examples are possible, within the scope of the claims.

What is claimed is:

1. An apparatus comprising:
a power stage configured to output a voltage; and
a controller configured to:
drive the power stage;
receive telemetry data related to the power stage;
determine information related to the power stage based on the telemetry data; and
transmit the determined information via a network communication.

2. The apparatus of claim 1, wherein the telemetry data comprises an input current of the power stage, an output current of the power stage, an input voltage of the power stage, an output voltage of the power stage, a temperature of the power stage, or communication data packets.

3. The apparatus of claim 1, further including an inductive device and a capacitor coupled between a load device and the power stage.

4. The apparatus of claim 3, wherein the information comprises a capacitance of the capacitor, an equivalent series inductance of the capacitor, an effective series resistance of the capacitor, an output inductance of the inductive device, a impedance of the inductive device, a impedance of a power distribution network path, an efficiency of the power stage, a leakage current of the power stage, an output power, a timestamp, inductor core loss, cooling failures, or a communication issue.

5. The apparatus of claim 1, wherein the controller includes an analog-to-digital converter configured to convert the received telemetry data into digital data, the controller configured to determine the information based on the digital data.

6. The apparatus of claim 1, wherein the controller is a first controller, and the first controller is configured to output the determined information to a second controller to transmit the determined information to an external storage device.

7. The apparatus of claim 1, wherein the controller is configured to identify a number of malformed communication packets.

8. The apparatus of claim 1, wherein the controller includes a buffer configured to store a number of samples of the telemetry data.

9. The apparatus of claim 8, wherein the controller is configured to:
identify a state change based on an instruction to adjust operation of the power stage;
based on the state change, stop sampling of the telemetry data; and
transmit the number of samples in the buffer to an external device.

10. A method comprising:
receiving, by a controller, analog telemetry power stage data;
converting, by an analog-to-digital (ADC) converter of the controller, the analog power stage telemetry data to digital telemetry data;
determining, by digital circuitry of the controller, a power stage characteristic based on the digital telemetry data; and
transmitting, by the controller, the power stage characteristic.

11. The method of claim 10, wherein the analog power stage telemetry data includes at least one of a power stage input current, a power stage output current, a power stage input voltage, a power stage output voltage, a power stage temperature, or communication data packets.

12. The method of claim 10, wherein the power stage characteristic includes at least one of a capacitance of a capacitor connected to a load device, an equivalent series inductance of the capacitor, an effective series resistance of the capacitor, an output inductance of an inductive device coupled to the power stage, a impedance of the inductive device, an on impedance of a power distribution network path, an efficiency of the power stage, a leakage current of the power stage, an output power, or a communication issue.

13. The method of claim 10, further including:
identifying a number of malformed communication packets from a load device; and
transmitting information corresponding to the number of malformed communication packets.

14. The method of claim 10, further including storing the digital telemetry data into a buffer.

15. The method of claim 14, further including:
identifying a state change;
based on the state change, stopping the converting of the analog power stage telemetry data to the digital telemetry data; and
transmitting the stored digital telemetry data in the buffer.

16. An apparatus comprising:
a driver including an input terminal and an output terminal, the output terminal of the driver structured adapted to be coupled to a power stage;
a first analog-to-digital converter including an input terminal and an output terminal, the input terminal of the first analog-to-digital converter structured adapted to be coupled to at least one of a terminal of a power converter, a terminal of the power stage, or a terminal of a load device;
a second analog-to-digital converter including an input terminal and an output terminal, the input terminal of the second analog-to-digital converter structured adapted to be coupled to at least one of the terminal of the power converter, the terminal of the power stage, or the terminal of the load device; and
digital circuitry including an output terminal, a first input terminal, and a second input terminal, the output terminal of the digital circuitry coupled to the input terminal of the driver, the first input terminal of the digital circuitry coupled to the output terminal of the first analog-to-digital converter, the second input terminal of the digital circuitry coupled to the output terminal of the second analog-to-digital converter.

17. The apparatus of claim 16, wherein:
the first analog-to-digital converter structured adapted to be coupled to a supply voltage terminal of the power stage; and
the second analog-to-digital converter structured adapted to be coupled to the load device via an interface.

18. The apparatus of claim 16, wherein the first analog-to-digital converter is structured to be coupled to an output terminal of the power stage.

19. The apparatus of claim 16, wherein the first analog-to-digital converter is coupled to a temperature sensor of the power stage.

20. The apparatus of claim 16, further including a third analog-to-digital converter including a first terminal and a second terminal, the first terminal of the third analog-to-digital converter coupled to the digital circuitry, the second terminal of the third analog-to-digital converter coupled to a board management controller.
